(19) United States
(12) Patent Application Publication
(10) Pub. No.: US 2006/0208442 A1
(43) Pub. Date: Sep. 21, 2006

(54) Water bottle container

(76) Inventor: Gary T. Hellermann, Arlington, WA (US)

Correspondence Address: ASHKAN NAJAFI, P.A., 6817 SOUTHPOINT PARKWAY, SUITE 2301, JACKSONVILLE, FL, 32216, US

(21) Appl. No.: 11/070,556

(22) Filed: Mar. 3, 2005

(51) Int. Cl. B62B 1/00

(52) U.S. Cl. 280/79.3

(57) ABSTRACT

A portable container includes a first body that has monolithically formed sidewalls sized and shaped for defining a storage cavity and further has an open front face. The first body includes monolithically formed shelves equidistantly registered between a top and bottom end portion of the first body. A plurality of 5-gallon water bottles can be directly passed through the open front face and nested into a partitioned region. Each shelf includes equally spaced flange portions protruding upwardly therefrom and each shelf further has a concave bottom surface on which the water bottles are supported. A plurality of access doors are pivotally attached to the first body and adaptable between open and closed positions. Each access door has a fulcrum axis defined along a vertical plane between the top and bottom end portions.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to containers and, more particularly, to a water bottle container for stacking, storing and transporting water bottles between remote locations.

2. Prior Art

The storage of filled water cooler bottles before use and the subsequent storage of empty water bottles after use pose a problem of ready access and aesthetic appearance. Filled water bottles are sometimes delivered to users as individual bottles, or alternatively, in stackable crate-like holders. Such crates are not interconnected and hence are easily slidable relative to one another, making the crates unstable and a possible source of injury.

In addition, such holders are unsightly and are frequently relegated to closets and other storage areas remote from the location of the water cooler. Thus, the space in the closet can no longer be used to store other items in more need of that space. Furthermore, this results in full (and hence heavy) water bottles having to be moved from their place of storage to the water cooler location. Similarly, the empty bottles must be moved back to the storage area.

It is also common practice to store full and empty water bottles in the garage. Although the bottles no longer occupy valuable space in the house, a user must now carry the heavy bottle from the garage to the house, which is a time and energy consuming process. Furthermore, garage temperatures are generally not under the control of the home's air conditioning system. Thus, when the full bottles are stored therein, the water has the same temperature as the ambient temperature, which is usually warmer than desired by a user.

Accordingly, a need remains for a water bottle container in order to overcome the above-noted shortcomings. The present invention satisfies such a need by providing a water bottle container that is easy to use, provides convenient storage, is sturdy in design, and has aesthetic appeal. Such a container will be available in different styles so that a consumer can conveniently choose the one best suiting his/her needs. The water bottle container advantageously saves space by providing a designated area for water bottles to be stored instead of being strewn about the kitchen or office. Such a container also advantageously prevents dirt and dust from settling atop the bottles. The water bottle container is a useful storage solution appreciable not only by home owners, but also businesses, office workers, and others.

### BRIEF SUMMARY OF THE INVENTION

In view of the foregoing background, it is therefore an object of the present invention to provide a water bottle container. These and other objects, features, and advantages of the invention are provided by a portable container for stacking and transporting water bottles between remote locations.

The portable container includes a first body that has a plurality of monolithically formed sidewalls sized and shaped for defining a storage cavity therein. Such a first body further has an open front face for conveniently providing direct access into the cavity. The first body includes a plurality of monolithically formed shelves vertically spaced and equidistantly registered between a top and bottom end portion of the first body such that the shelves define a plurality of partitioned regions within the cavity.

Such partitioned regions are proportionally juxtaposed along a plurality of horizontal planes respectively wherein a plurality of 5-gallon water bottles can conveniently be directly passed through the open front face and removably nested into a corresponding one of the partitioned regions during loading and unloading procedures. The partitioned regions are uniformly situated within the cavity for advantageously assisting the user to deposit and retrieve one 5-gallon water bottle without moving other ones of the 5-gallon water bottles during loading and unloading procedures. Such partitioned regions are preferably coextensive.

Each shelf includes a plurality of monolithically formed flange portions protruding upwardly therefrom and along a substantially vertically plane. Such flange portions are equally spaced apart along a horizontal length of a corresponding shelf. Each such shelf further has a concave bottom surface for defining a beveled arcuate shape intermediate of the flange portions and on which the 5-gallon water bottles are supported.

A plurality of access doors are pivotally attached to the first body and selectively adaptable between open and closed positions. Each access door has a fulcrum axis defined along a substantially vertical plane extending between the top and bottom end portions respectively. Each fulcrum axis is equidistantly spaced apart from a central portion of the body and maintains a fixed relationship along opposite ones of the sidewalls such that the access doors can conveniently be articulated along independent arcuate paths as desired by the user. The access doors preferably include coextensive and rigid outer frames and coextensive and transparent panels centrally conjoined within the outer frames such that the user can conveniently maintain an unobstructed line of sight between an exterior of the body and the cavity respectively.

The portable container may further include a plurality of caster wheels operably conjoined to the bottom end portion of the first body and extending downwardly therefrom for advantageously allowing a user to quickly and readily roll the container along a ground surface.

In an alternate embodiment, the container may further include a second body coextensively dimensioned with the first body. In such an embodiment, one of the sidewalls may be chamfered and provided with a plurality of rectilinear grooves extending between a rear face and the front face of the first and second bodies. Another sidewall is preferably provided with a plurality of monolithically formed rib portions extending downwardly therefrom and proportionally registered with the grooves such that the first and second bodies can conveniently be vertically stacked along a vertical plane and maintained at a substantially stable position during transit.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing a water bottle container, in accordance with the present invention;

FIG. 2 is a cross-sectional view of the apparatus shown in FIG. 1, taken along line 2-2; and

FIG. 3 is perspective view showing an alternate embodiment of the water bottle container, in accordance with the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art. Like numbers refer to like elements throughout the figures and prime and double prime numbers refer to alternate embodiments of such elements.

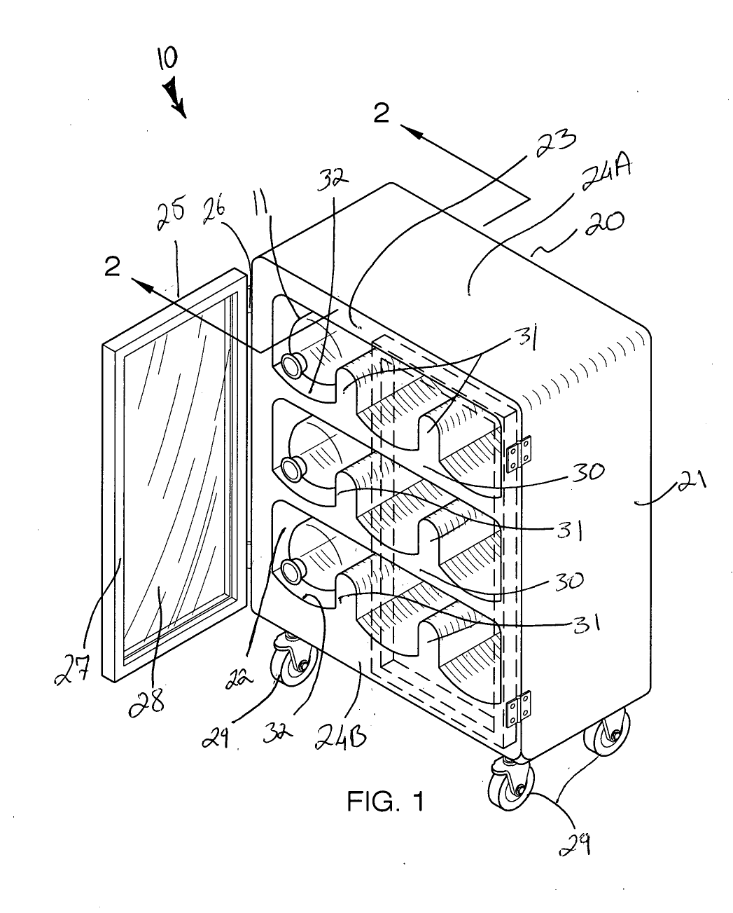

The apparatus of this invention is referred to generally in FIGS. 1-3 by the reference numeral 10 and is intended to provide a water bottle container. It should be understood that the apparatus 10 may be used to store and transport many different types of bottles and should not be limited in use to only water bottles.

Referring initially to FIG. 1, the apparatus 10 includes a first body 20 that has a plurality of monolithically formed sidewalls 21 sized and shaped for defining a storage cavity 22 therein. Of course, the body 20 may be produced in a variety of different shapes, sizes and colors, as is obvious to a person of ordinary skill in the art. Such a first body 20 further has an open front face 23 for conveniently providing direct access into the cavity 22. The first body 20 includes a plurality of monolithically formed shelves 30 vertically spaced and equidistantly registered between a top 24A and bottom 24B end portion of the first body 20 such that the shelves 30 define a plurality of partitioned regions within the cavity 22.

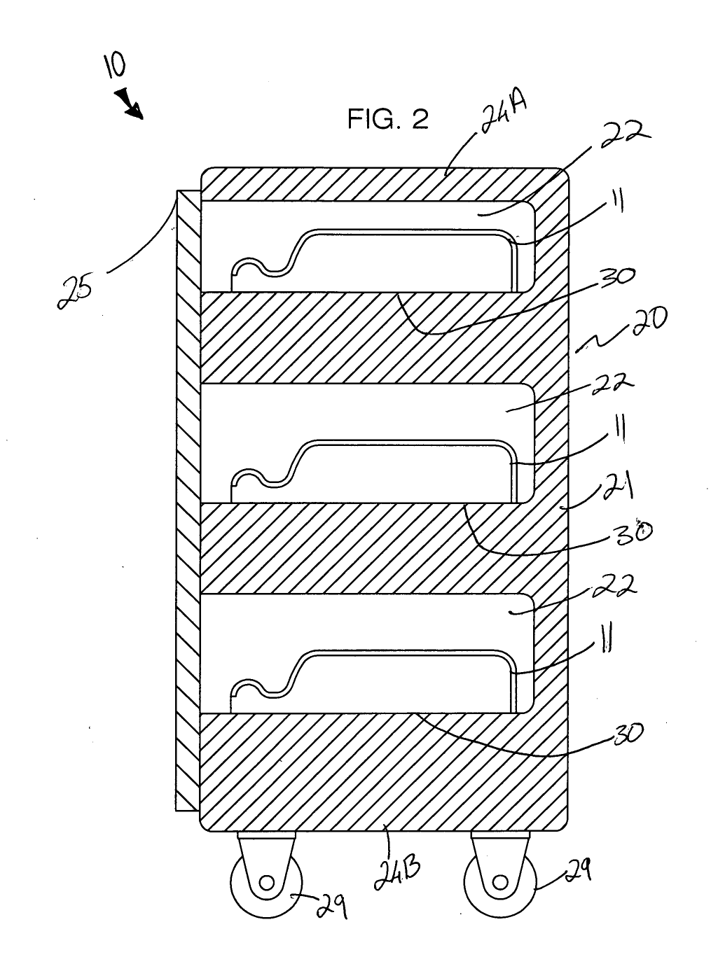

Referring to FIG. 2, such partitioned regions are proportionally juxtaposed along a plurality of horizontal planes respectively wherein a plurality of 5-gallon water bottles 11 can conveniently be directly passed through the open front face 23 and removably nested into a corresponding one of the partitioned regions during loading and unloading procedures. The partitioned regions are uniformly situated within the cavity 22 for advantageously assisting the user to deposit and retrieve one 5-gallon water bottle 11 without moving other ones of the 5-gallon water bottles 11 during loading and unloading procedures, thus requiring less time and energy. Such partitioned regions are coextensive.

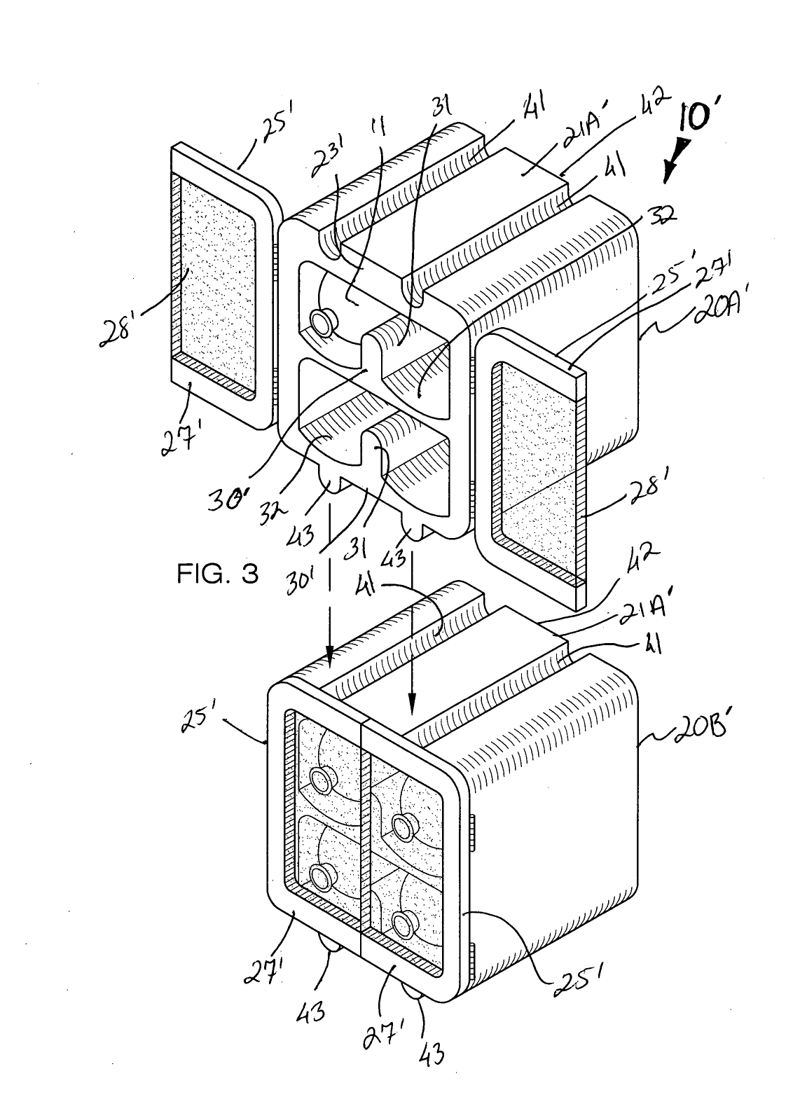

Referring to FIGS. 1 and 3, each shelf 30 includes a plurality of monolithically formed flange portions 31 protruding upwardly therefrom and along a substantially vertically plane. Such flange portions 31 are equally spaced apart along a horizontal length of a corresponding shelf 30. Each such shelf 30 further has a concave bottom surface 32 for defining a beveled arcuate shape intermediate of the flange portions 31 and on which the 5-gallon water bottles 11 are supported. The flange portions 31 conveniently isolate the water bottles 11 from each other, which further assists in easy loading and unloading.

Referring to FIGS. 1 through 3, a plurality of access doors 25 are pivotally attached to the first body 20 and selectively adaptable between open and closed positions. Each access door 25 has a fulcrum axis 26 defined along a substantially vertical plane extending between the top 24A and bottom 24B end portions respectively. Each fulcrum axis 26 is equidistantly spaced apart from a central portion of the body 20 and maintains a fixed relationship along opposite ones of the sidewalls 21 such that the access doors 25 can conveniently be articulated along independent arcuate paths as desired by the user. The access doors 25 further include coextensive and rigid outer frames 27 and coextensive and transparent panels 28 centrally conjoined within the outer frames 27 such that the user can conveniently maintain an unobstructed line of sight between an exterior of the body 20 and the cavity 22 respectively. The containers 10 may also be provided with a cooling mechanism (not shown) to keep the water bottles 11 cool when the doors 25 are at a closed position, as is obvious to a person of ordinary skill in the art.

Referring to FIGS. 1 and 2, the portable container 10 further includes a plurality of caster wheels 29 operably conjoined to the bottom end portion 24B of the first body 20 and extending downwardly therefrom for advantageously allowing a user to quickly and readily roll the container 10 along a ground surface with minimal effort. Such wheels 29 also eliminate the need to carry the water bottles 11 from one location to another, which in turn decreases the risk of sustaining a back injury due to excessive strain.

Referring to FIG. 3, in an alternate embodiment, the container 10′ further includes a second body 20B′ coextensively dimensioned with the first body 20A′. In such an embodiment 10′, one 21A′ of the sidewalls 21′ is chamfered and provided with a plurality of rectilinear grooves 41 extending between a rear face 42 and the front face 23′ of the first 20A′ and second 20B′ bodies. Another sidewall 21B′ is provided with a plurality of monolithically formed rib portions 43 extending downwardly therefrom and proportionally registered with the grooves 41 such that the first 20A′ and second 20B′ bodies can conveniently be vertically stacked along a vertical plane and maintained at a substantially stable position during transit. The grooves 41 and ribs 43 advantageously reduce the risk of tipping associated with the bodies 20A′, 20B′, which could otherwise lead to serious injury.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A portable container for stacking and transporting water bottles between remote locations, said portable container comprising:
a first body having a plurality of monolithically formed sidewalls sized and shaped for defining a storage cavity therein, said first body further having an open front face for providing direct access into the cavity, said first body including a plurality of monolithically formed shelves vertically spaced and equidistantly registered between a top and bottom end portion of said first body such that said shelves define a plurality of partitioned regions within the cavity, said partitioned regions being proportionally juxtaposed along a plurality of horizontal planes respectively wherein a plurality of 5-gallon water bottles can be directly passed through said open front face and removably nested into a corresponding one of said partitioned regions during loading and unloading procedures; and
a plurality of access doors pivotally attached to said first body and selectively adaptable between open and closed positions, each said access door having a fulcrum axis defined along a substantially vertical plane extending between said top and bottom end portions respectively, each fulcrum axis being equidistantly spaced apart from a central portion of said body and maintaining a fixed relationship along opposite ones of said sidewalls such that said access doors can be articulated along independent arcuate paths as desired by the user.

2. The portable container of claim 1, further comprising: a plurality of caster wheels operably conjoined to said bottom end portion of said first body and extending downwardly therefrom for allowing a user to quickly and readily roll said container along a ground surface.

3. The portable container of claim 1, further comprising: a second body coextensively dimensioned with said first body.

4. The portable container of claim 1, wherein one said sidewalls is chamfered and provided with a plurality of rectilinear grooves extending between a rear face and said front face of said first and second bodies, another said sidewalls is provided with a plurality of monolithically formed rib portions extending downwardly therefrom and proportionally registered with said grooves such that said first and second bodies can be vertically stacked along a vertical plane and maintained at a substantially stable position during transit.

5. The portable container of claim 1, wherein said access doors comprise:
coextensive and rigid outer frames; and
coextensive and transparent panels centrally conjoined within said outer frames such that the user can maintain an unobstructed line of sight between an exterior of said body and the cavity respectively.

6. The portable container of claim 1, wherein said partitioned regions are coextensive.

7. A portable container for stacking and transporting water bottles between remote locations, said portable container comprising:
a first body having a plurality of monolithically formed sidewalls sized and shaped for defining a storage cavity therein, said first body further having an open front face for providing direct access into the cavity, said first body including a plurality of monolithically formed shelves vertically spaced and equidistantly registered between a top and bottom end portion of said first body such that said shelves define a plurality of partitioned regions within the cavity, said partitioned regions being proportionally juxtaposed along a plurality of horizontal planes respectively wherein a plurality of 5-gallon water bottles can be directly passed through said open front face and removably nested into a corresponding one of said partitioned regions during loading and unloading procedures;
wherein each said shelf comprises: a plurality of monolithically formed flange portions protruding upwardly therefrom and along a substantially vertically plane, said flange portions being equally spaced apart along a horizontal length of a corresponding shelf, each said shelf further having a concave bottom surface for defining a beveled arcuate shape intermediate of said flange portions and on which the 5-gallon water bottles are supported; and
a plurality of access doors pivotally attached to said first body and selectively adaptable between open and closed positions, each said access door having a fulcrum axis defined along a substantially vertical plane extending between said top and bottom end portions respectively, each fulcrum axis being equidistantly spaced apart from a central portion of said body and maintaining a fixed relationship along opposite ones of said sidewalls such that said access doors can be articulated along independent arcuate paths as desired by the user.

8. The portable container of claim 7, further comprising: a plurality of caster wheels operably conjoined to said bottom end portion of said first body and extending downwardly therefrom for allowing a user to quickly and readily roll said container along a ground surface.

9. The portable container of claim 7, further comprising: a second body coextensively dimensioned with said first body.

10. The portable container of claim 7, wherein one said sidewalls is chamfered and provided with a plurality of rectilinear grooves extending between a rear face and said front face of said first and second bodies, another said sidewalls is provided with a plurality of monolithically formed rib portions extending downwardly therefrom and proportionally registered with said grooves such that said first and second bodies can be vertically stacked along a vertical plane and maintained at a substantially stable position during transit.

11. The portable container of claim 7, wherein said access doors comprise:
coextensive and rigid outer frames; and
coextensive and transparent panels centrally conjoined within said outer frames such that the user can maintain an unobstructed line of sight between an exterior of said body and the cavity respectively.

12. The portable container of claim 7, wherein said partitioned regions are coextensive.

13. A portable container for stacking and transporting water bottles between remote locations, said portable container comprising:
a first body having a plurality of monolithically formed sidewalls sized and shaped for defining a storage cavity therein, said first body further having an open front face for providing direct access into the cavity, said first body including a plurality of monolithically formed shelves vertically spaced and equidistantly registered between a top and bottom end portion of said first body such that said shelves define a plurality of partitioned regions within the cavity, said partitioned regions being proportionally juxtaposed along a plurality of horizontal planes respectively wherein a plurality of 5-gallon water bottles can be directly passed through said open front face and removably nested into a corresponding one of said partitioned regions during loading and unloading procedures, said partitioned regions being uniformly situated within the cavity for assisting the user to deposit and retrieve one 5-gallon water bottle without moving other ones of the 5-gallon water bottles during loading and unloading procedures;
wherein each said shelf comprises: a plurality of monolithically formed flange portions protruding upwardly therefrom and along a substantially vertically plane, said flange portions being equally spaced apart along a horizontal length of a corresponding shelf, each said shelf further having a concave bottom surface for defining a beveled arcuate shape intermediate of said flange portions and on which the 5-gallon water bottles are supported; and
a plurality of access doors pivotally attached to said first body and selectively adaptable between open and closed positions, each said access door having a fulcrum axis defined along a substantially vertical plane extending between said top and bottom end portions respectively, each fulcrum axis being equidistantly spaced apart from a central portion of said body and maintaining a fixed relationship along opposite ones of said sidewalls such that said access doors can be articulated along independent arcuate paths as desired by the user.

14. The portable container of claim 13, further comprising: a plurality of caster wheels operably conjoined to said bottom end portion of said first body and extending downwardly therefrom for allowing a user to quickly and readily roll said container along a ground surface.

15. The portable container of claim 13, further comprising: a second body coextensively dimensioned with said first body.

16. The portable container of claim 13, wherein one said sidewalls is chamfered and provided with a plurality of rectilinear grooves extending between a rear face and said front face of said first and second bodies, another said sidewalls is provided with a plurality of monolithically formed rib portions extending downwardly therefrom and proportionally registered with said grooves such that said first and second bodies can be vertically stacked along a vertical plane and maintained at a substantially stable position during transit.

17. The portable container of claim 13, wherein said access doors comprise:
coextensive and rigid outer frames; and
coextensive and transparent panels centrally conjoined within said outer frames such that the user can maintain an unobstructed line of sight between an exterior of said body and the cavity respectively.

18. The portable container of claim 13, wherein said partitioned regions are coextensive.
